(19) United States
(12) Patent Application Publication
(10) Pub. No.: US 2008/0217294 A1
(43) Pub. Date: Sep. 11, 2008

(54) METHOD AND SYSTEM FOR ETCHING A HAFNIUM CONTAINING MATERIAL

(75) Inventors: Akiteru Ko, Peabody, MA (US); Takashi Enomoto, Rensselaer, NY (US); Asao Yamashita, Fishkill, NY (US)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/684,072

(22) Filed: Mar. 9, 2007

(51) Int. Cl. B44C 1/22; G06F 19/00

(52) U.S. Cl. 216/57; 700/96

(57) ABSTRACT

A method of etching a hafnium containing layer includes disposing a substrate having the hafnium containing layer in a plasma processing system, wherein a mask layer defining a pattern therein overlies the hafnium containing layer. A process gas including a HBr gas is introduced to the plasma processing system, and a plasma is formed from the process gas in the plasma processing system. The hafnium containing layer is exposed to the plasma in order to treat the hafnium containing layer. The hafnium containing layer is then wet etched using a dilute HF wet etch process.

### FIELD OF THE INVENTION

The present invention relates to a method and system for etching a hafnium containing layer, whereby the hafnium containing layer is treated in a first step and then etched in a second step.

### BACKGROUND OF THE INVENTION

As is known to those in the semiconductor art, the reduction in size of semiconductor devices has been indispensably necessary in order to cause an increase in device performance and a decrease in power consumption. Accordingly, process development and integration issues are key challenges for new gate stack materials and silicide processing, with the imminent replacement of SiO₂ and Si-oxynitride (SiNₓO_{y}) with high-permittivity dielectric materials (also referred to herein as “high-k” materials), and the use of alternative gate electrode materials to replace doped poly-Si in sub-0.1 μm complementary metal-oxide semiconductor (CMOS) technology.

Dielectric materials featuring a dielectric constant greater than that of SiO₂ (k˜3.9) are commonly referred to as high-k materials. In addition, high-k materials may refer to dielectric materials that are deposited onto substrates (e.g., HfO₂, ZrO₂) rather than grown on the surface of the substrate (e.g., SiO₂, SiNₓO_{y}). High-k materials may incorporate metallic silicates or oxides (e.g., Ta₂O₅ (k˜26), TiO₂ (k˜80), ZrO₂ (k˜25), Al₂O₃ (k˜9), HfSiO, HfO₂ (k˜25)).

Oxides of hafnium, such as HfOₓ and HfSiO_{y} are being considered and tested to replace SiO₂ as the gate dielectric. Although these materials have the high-k values needed to provide a large equivalent oxide thickness, these materials are very refractory and difficult to etch by wet and dry methods. For example, known plasma dry etch techniques have poor selectivity with respect to the underlying substrate, and therefore plasma etching of the high-k layer results in damage such as Si recess damage in the source and drain regions of the substrate beneath the high-k layer. While wet etch techniques using HF solutions, for example, can reduce Si recess damage, such etch processes are isotropic and can therefore undesirably etch or undercut the high-k gate dielectric layer beneath the conductor in the gate stack. Further, it has been found that as-deposited high-k films can be dissolved in dilute HF solutions to facilitate etching, however annealed high-k films such as HfSiO are difficult to etch under the same conditions.

### BRIEF DESCRIPTION OF THE DRAWINGS

In the accompanying drawings:

FIG. 1 illustrates a schematic representation of a procedure for pattern etching a film stack;

FIG. 2 shows a plasma processing system according to an embodiment of the present invention;

FIG. 3 shows a plasma processing system according to another embodiment of the present invention;

FIG. 4 shows a plasma processing system according to yet another embodiment of the present invention;

FIG. 5 shows a flowchart illustrating a method of etching a hafnium containing layer according to an embodiment of the invention; and

FIG. 6 shows a schematic representation of an example gate stack in which an exposed polysilicon has been removed exposing a HfSiO layer;

FIG. 7 shows a TEM image of an example gate stack following plasma processing and wet-etching of the HfSiO layer according to an embodiment of the invention; and

FIG. 8 shows a Dark Field STEM image of a gate stack following plasma processing and wet-etching of a HfSiO layer according to an embodiment of the invention.

### DETAILED DESCRIPTION OF SEVERAL EMBODIMENTS

In the following description, for purposes of explanation and not limitation, specific details are set forth, such as a particular geometry of the plasma processing system and descriptions of various processes. However, it should be understood that the invention may be practiced in other embodiments that depart from these specific details.

In material processing methodologies, pattern etching includes the application of a thin layer of light-sensitive material, such as photoresist, to an upper surface of a substrate that is subsequently patterned to provide a mask for transferring this pattern to the underlying thin film on a substrate during etching. The term “substrate” is used broadly herein to describe a semiconductor wafer to which photoresist can be applied to process the wafer. Thus, a substrate may be a bare semiconductor wafer, or a previously processed wafer including a SOI layer or a multi-gate transistor body for example. The term “substrate” is used broadly herein to describe a wafer to which photoresist can be applied to process the wafer. Thus, a substrate may be a bare semiconductor wafer, or a previously processed wafer including a SOI layer or a multi-gate transistor body, for example. The patterning of the light-sensitive material generally involves exposure by a radiation source through a reticle (and associated optics) of the light-sensitive material using, for example, a photo-lithography system, followed by the removal of the irradiated regions of the light-sensitive material (as in the case of positive photoresist), or non-irradiated regions (as in the case of negative resist) using a developing solvent. Moreover, this mask layer may include multiple sub-layers.

During pattern etching, an anisotropic plasma etch process is often utilized, wherein plasma is formed from a process gas by coupling electro-magnetic (EM) energy, such as radio frequency (RF) power, to the process gas to heat electrons and cause subsequent ionization and dissociation of the atomic and/or molecular composition of the process gas.

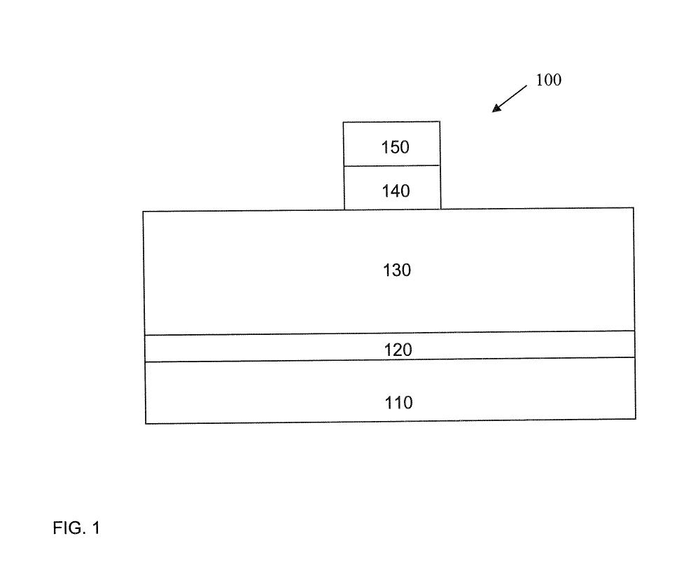

For example, as shown in FIG. 1, a film stack 100 including layers 120 through 150 formed on a channel 110 is illustrated. The film stack 100 may, for example, include a polycrystalline silicon (polysilicon, or poly-Si) gate stack having a polysilicon layer 130 and a high dielectric constant (high-k) dielectric layer 120 as the gate dielectric or part of the gate dielectric. Alternatively, the layer 130 may be metal or a combination of at least one polysilicon layer and at least one metal layer. The high-k dielectric layer 120 may, for example, include a hafnium containing layer, such as a hafnium oxide layer (HfOₓ, e.g., HfO₂) or hafnium silicate layer (HfSiO_{y}, e.g., HfSiO). Further, the high-K dielectric layer may be a thermally annealed hafnium containing layer. The film stack 100 further includes a photoresist layer 150. Additionally, for example, the film stack 100 may include an anti-reflective coating (ARC) layer 140 for etching the polysilicon layer 130. The ARC layer 140 and photoresist layer 150 are shown after patterning in FIG. Conventional processes for etching a hafnium containing high-k layer include anisotropically eroding the high-K dielectric material using a dry-etch process including carbon tetrachloride CCl₄, oxygen O₂ and helium in a magnetically enhanced reactive ion etching (MERIE) or an electron cyclotron resonance (ECR) chamber or tool. The high-K dielectric material is then etched using a dilute HF wet-etch process. However, the present inventors have recognized that using a chlorinated/fluorinated plasma etch followed by a dilute HF(aq) solution to etch the high-K material has the disadvantage that the process is very slow. For example, such conventional etch processes typically provide an etch rate of 35-40 Å/min. The inventors recognized that this slow etch rate reduces manufacturing throughput and can cause long HF exposure damage to oxide structures of the device.

According to one embodiment, the pattern etching process for transferring a pattern into high-k dielectric layer 120 includes treating the high-k dielectric layer 120 using a plasma etch process, and then exposing the treated layer to a wet etch process. In one embodiment, the polysilicon and/or metal layer are removed down to the high-k dielectric layer 120, and the high-k dielectric layer 120 is etched by first plasma treating the high-K layer with a HBr gas containing plasma, and then exposing the high-K layer to a wet etch process. In another embodiment where a polysilicon layer is provided on the high-K layer, an anisotropic etch process using a HBr containing plasma is used to etch and over-etch the polysilicon layer 130 during the polysilicon etch process resulting in the altering or treatment of the surface of the high-k dielectric layer 120 prior to etching the high-k dielectric layer with a dilute HF(aq) solution. Thus, the present inventors discovered that a two-step process using HBr plasma treatment followed by wet etch can provide improvements in the speed of the high-k dielectric etching.

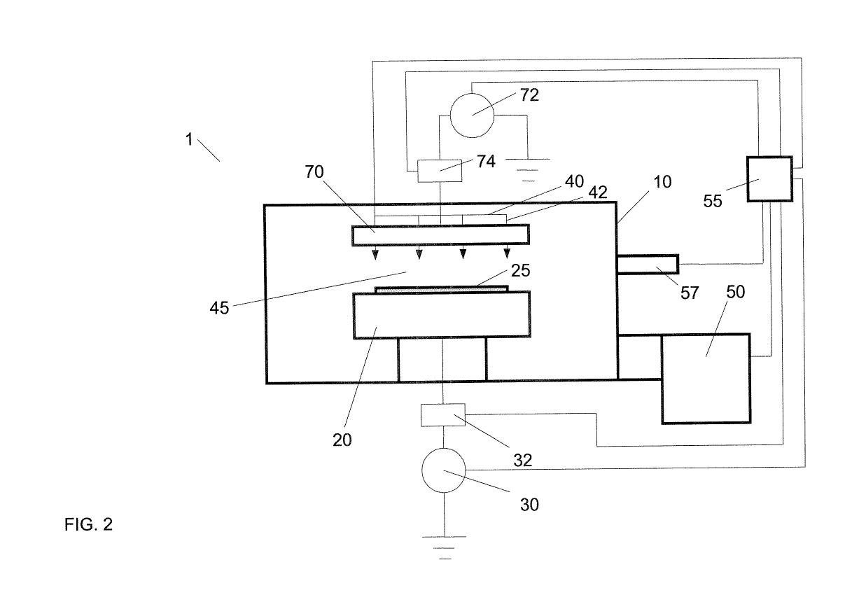

FIG. 2 shows a plasma processing system that can perform the plasma treatment step of the high-K layer according to an embodiment of the invention. The plasma processing system 1 is configured to facilitate the generation of plasma in processing region 45 of the process chamber 10. The plasma processing system 1 further includes a substrate holder 20, upon which a substrate 25 to be processed is affixed and makes electrical contact to, and a gas injection system 40 for introducing process gas 42 to the plasma process chamber 10, and a vacuum pumping system 50. The gas injection system 40 allows independent control over the delivery of the process gas 42 to the process chamber 10 from ex-situ gas sources.

An ionizable process gas 42 is introduced via the gas injection system 40 and the process pressure is adjusted. The flow rate of the process gas can be between about 10 sccm and about 5000 sccm, alternately between about 20 sccm and about 1000 sccm, and still alternately between about 50 sccm and about 500 sccm. The chamber pressure can, for example, be between about 1 mTorr and about 200 mTorr, alternately between about 5 mTorr and about 100 mTorr, still alternately between about 10 mTorr and about 50 mTorr. The controller 55 can be used to control the vacuum pumping system 50 and gas injection system 40. Substrate 25 is transferred into process chamber 10 through a slot valve (not shown) and chamber feed-through (not shown) via a (robotic) substrate transfer system where it is received by substrate lift pins (not shown) housed within substrate holder 20 and mechanically translated by devices housed therein. Once the substrate 25 is received from the substrate transfer system, it is lowered to an upper surface of the substrate holder 20.

In an alternate embodiment, the substrate 25 is affixed to the substrate holder 20 via an electrostatic clamp (not shown). Furthermore, the substrate holder 20 further includes a cooling system including a re-circulating coolant flow that receives heat from the substrate holder 20 and transfers heat to a heat exchanger system (not shown), or when heating, transfers heat from the heat exchanger system. Moreover, gas may be delivered to the backside of the substrate to improve the gas-gap thermal conductance between the substrate 25 and the substrate holder 20. Such a system is utilized when temperature control of the substrate is required at elevated or reduced temperatures. For example, temperature control of the substrate may be useful at temperatures in excess of the steady-state temperature achieved due to a balance of the heat flux delivered to the substrate 25 from the plasma and the heat flux removed from substrate 25 by conduction to the substrate holder 20. In other embodiments, heating elements, such as resistive heating elements, or thermoelectric heaters/coolers are included in the substrate holder 20.

The plasma processing system 1 of FIG. 2 includes a RF plasma source that contains an upper plate electrode 70 to which RF power is coupled from a first RF generator 72 through a first impedance match network 74. A typical frequency for the application of RF power to the upper plate electrode 70 can range from 10 MHz to 200 MHz and can be 60 MHz. The RF power applied to the upper plate electrode 70 can be between about 50 Watts (W) and about 5,000 W. Alternately, the RF power applied to the upper plate electrode 70 can be between about 100 W and about 1,000 W. As noted above, the plasma processing system 1 of FIG. 2 further includes a RF source for applying RF power to the substrate holder 20 to bias the substrate 25. The RF source contains a second RF generator 30 and a second impedance match network 32 that serves to maximize the transfer of RF power to plasma to the processing region 45 by minimizing the reflected power. Match network topologies (e.g., L-type, π-type, T-type) and automatic control methods are known in the art. A typical frequency for the application of power to the substrate holder 20 ranges from 0.1 MHz to 30 MHz and can be 2 MHz. The RF power applied to the substrate holder 20 can be between about 10 W and about 500 W. Alternately, the RF power applied to the substrate holder 20 can be between about 20 W and about 100 W. Moreover, the controller 55 is coupled to the first RF generator 72 and the first impedance match network 74 in order to control the application of RF power to the upper plate electrode 70. In an alternate embodiment, RF power can be applied to the substrate holder 20 at multiple frequencies. Further, in the embodiment of FIG. 2, multiple frequencies can be delivered to the processing system 1 simultaneously, in parallel, or in sequence using the first RF generator 72 and the second RF generator 30.

With continuing reference to FIG. 2, a process gas 42 is introduced to the processing region 45 through the gas injection system 40. Gas injection system 40 can include a showerhead, wherein the process gas 42 is supplied from a gas delivery system (not shown) to the processing region 45 through a gas injection plenum (not shown), a series of baffle plates (not shown) and a multi-orifice showerhead gas injection plate. In one embodiment, the multi-orifice showerhead gas injection plate can be the upper plate electrode 70.

Vacuum pump system 50 can include a turbo-molecular vacuum pump (TMP) capable of a pumping speed up to 5000 liters per second (and greater), and a gate valve for throttling the chamber pressure. In conventional plasma processing devices utilized for dry plasma etch, a 1000 to 3000 liter per second TMP (in combination with a mechanical pump) is employed. TMPs are useful for low pressure processing, typically less than 50 mTorr. For high pressure processing (i.e. greater than 100 mTorr), a mechanical booster pump and dry roughing pump are used.

A controller 55 includes a microprocessor, a memory, and a digital I/O port capable of generating control voltages sufficient to communicate and activate inputs to the plasma processing system 1 as well as monitor outputs from the plasma processing system 1. Moreover, the controller 55 is coupled to and exchanges information with the RF generator 30, the impedance match network 32, the RF generator 72, the impedance match network 74, the gas injection system 40, plasma monitor system 57, and the vacuum pump system 50. A program stored in the memory is utilized to control the aforementioned components of a plasma processing system 1 according to a stored process recipe. One example of controller 55 is a digital signal processor (DSP); model number TMS320, available from Texas Instruments, Dallas, Tex.

The plasma monitor system 57 can include, for example, an optical emission spectroscopy (OES) system to measure excited particles in the plasma environment and/or a plasma diagnostic system, such as a Langmuir probe, for measuring plasma density. The plasma monitor system 57 can be used with controller 55 to determine the status of the etching process and provide feedback to ensure process compliance. Alternately, plasma monitor system 57 can include a microwave and/or a RF diagnostic system.

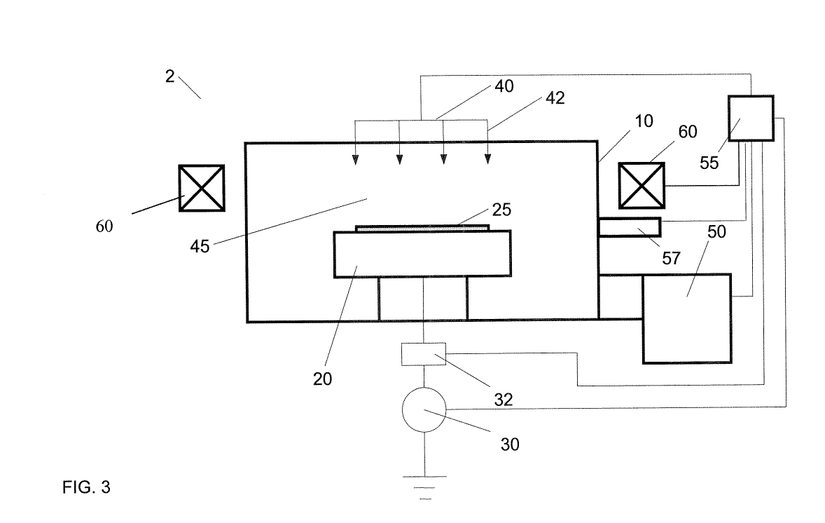

FIG. 3 shows a plasma processing system according to another embodiment of the invention. The plasma processing system 2 includes a RF plasma source including either a mechanically or electrically rotating DC magnetic field system 60, to potentially increase plasma density and/or improve plasma processing uniformity. Moreover, the controller 55 is coupled to the rotating magnetic field system 60 to regulate the speed of rotation and field strength.

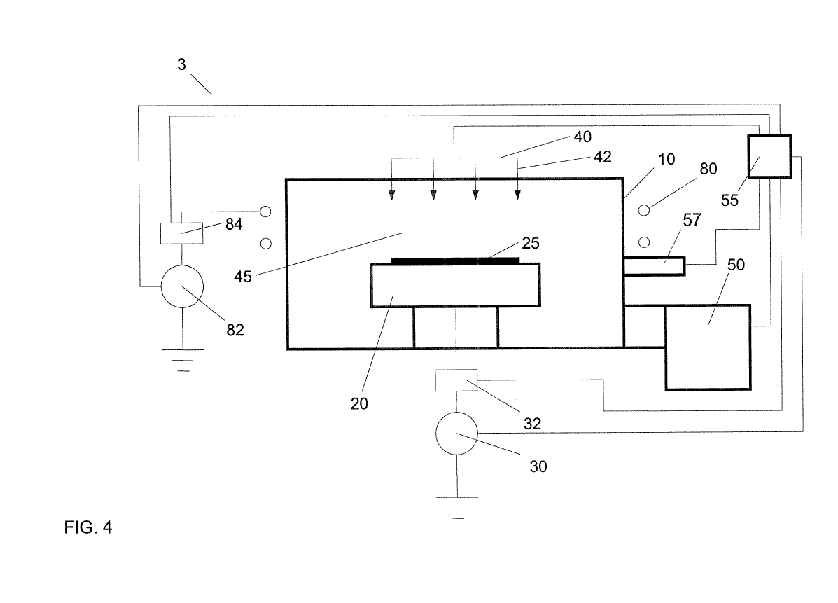

FIG. 4 shows a plasma processing system according to yet another embodiment of the present invention. The plasma processing system 3 includes a RF plasma source including an inductive coil 80 to which RF power is coupled via a RF generator 82 through an impedance match network 84. RF power is inductively coupled from the inductive coil 80 through a dielectric window (not shown) to the plasma-processing region 45. A typical frequency for the application of RF power to the inductive coil 80 ranges from 0.1 MHz to 100 MHz and can be 13.56 MHz. The RF power applied to the inductive coil can be between about 50 W and about 10,000 W. Similarly, a typical frequency for the application of power to the chuck electrode ranges from 0.1 MHz to 30 MHz and can be 13.56 MHz. The RF power applied to the substrate holder can be between about 10 W and about 500 W. In addition, a slotted Faraday shield (not shown) can be employed to reduce capacitive coupling between the inductive coil 80 and plasma. Moreover, the controller 55 is coupled to the RF generator 82 and the impedance match network 84 to control the application of power to the inductive coil 80.

It is to be understood that the plasma processing systems depicted in FIGS. 2-4 are shown for exemplary purposes only, as many variations of the specific hardware can be used to implement processing systems in which the present invention may be practiced, and these variations will be readily apparent to one having ordinary skill in the art.

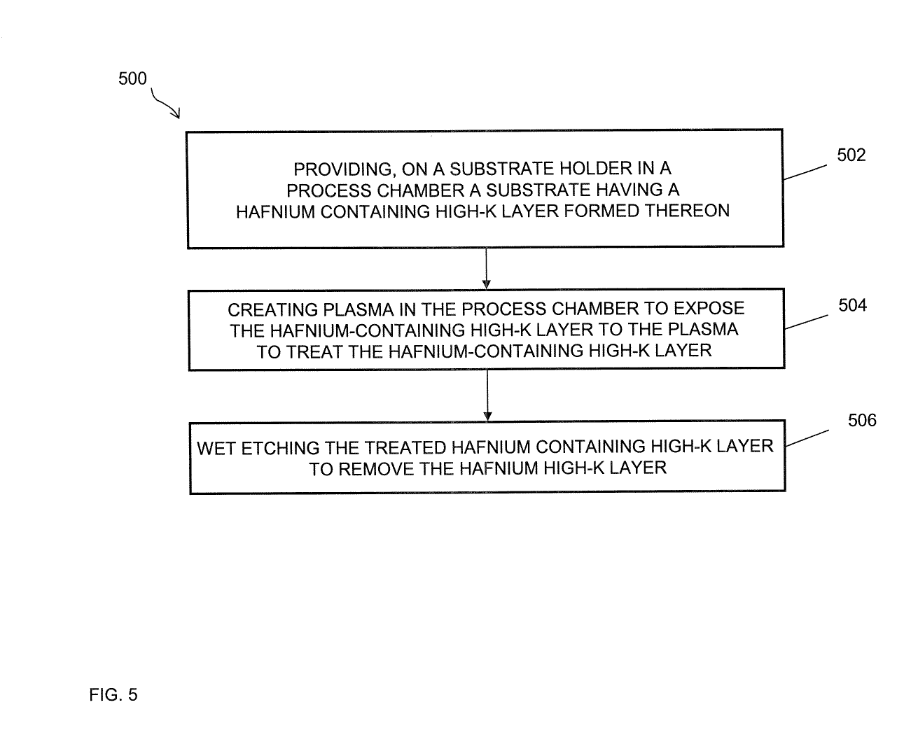

As noted above, the plasma treated high-k layer is etched in a wet etch process using an HF solution, for example. The wet etch process is typically performed in a separate processing tool from the plasma chamber. The wet etch process may be performed in a single wafer or batch wafer wet bath treatment system. For example, single wafer wet etch can be performed in a CELLESTA™ system, and a batch wafer etch may be performed in an EXPEDIUS™ or EXPEDIUS PLUS™ batch immersion system all of these systems being commercially available from Tokyo Electron Limited. FIG. 5 shows a flowchart illustrating a method for etching a hafnium containing layer according to an embodiment of the invention. The process 500 includes at 502, providing in a process chamber a substrate having a hafnium containing layer thereon. For example, the hafnium containing layer may be HfOₓ or HfSiO_{y}, or a combination thereof. In one embodiment, the substrate includes a hafnium containing high-k layer formed thereon and a polysilicon layer on the high-k layer. The process chamber includes a RF plasma source and a RF source for powering the substrate holder supporting the substrate. For example, the process chamber may be one of the chambers discussed in FIGS. 2-4.

At 504, a process gas is provided to the process chamber and a plasma is created in the process chamber to expose the hafnium containing high-k layer to the plasma. Embodiments of the current invention can be applied to processing plasmas containing a process gas that includes an inert gas, a reactive gas, or both. The inert gas can contain He, Ne, Ar, Kr, or Xe, or a combination of two or more thereof. The reactive gas can include a HBr/O₂/He. In this embodiment, HBr can be provided at a flow rate of about 40-500 sccm, O₂ at about 1-20 sccm, and He at about 50-500 sccm. In one embodiment, Ar can be added at a flow rate of about 100-500 sccm. Further, the HBr plasma process can be performed for about 20-120 seconds at a chamber pressure of about 10-150 mT. RF power can be coupled to the plasma at about 0-300 W on the top electrode and about 50-300 W on the bottom electrode.

In one embodiment, step 504 is performed as an overetch after exposing the polysilicon layer to the plasma to dry etch the polysilicon. In this embodiment, the process step 504 is carried out for the desired amount of time to remove the polysilicon layer and to treat the high-k layer using a plasma etch surface treatment.

In 506, the thermally annealed high-k layer is wet-etched using a dilute HF(aq) (Hydrogen Fluoride) solution. Since the high-k layer was treated in step 504, the wet-etching step 506 quickly removes the treated high-k layer. In one embodiment the substrate having the treated high-k layer thereon is immersed in a bath of H₂O:HF solution for a time period of about 10-120 seconds. The H₂O:HF ration can be from about 100:1 to 400:1.

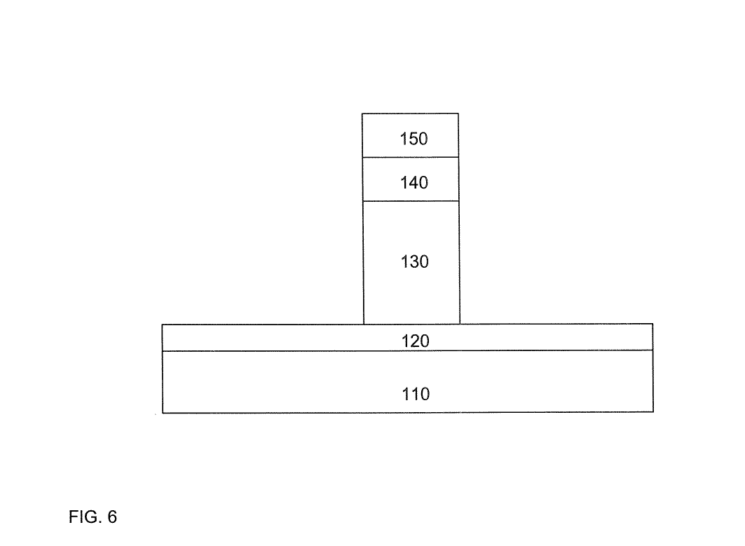

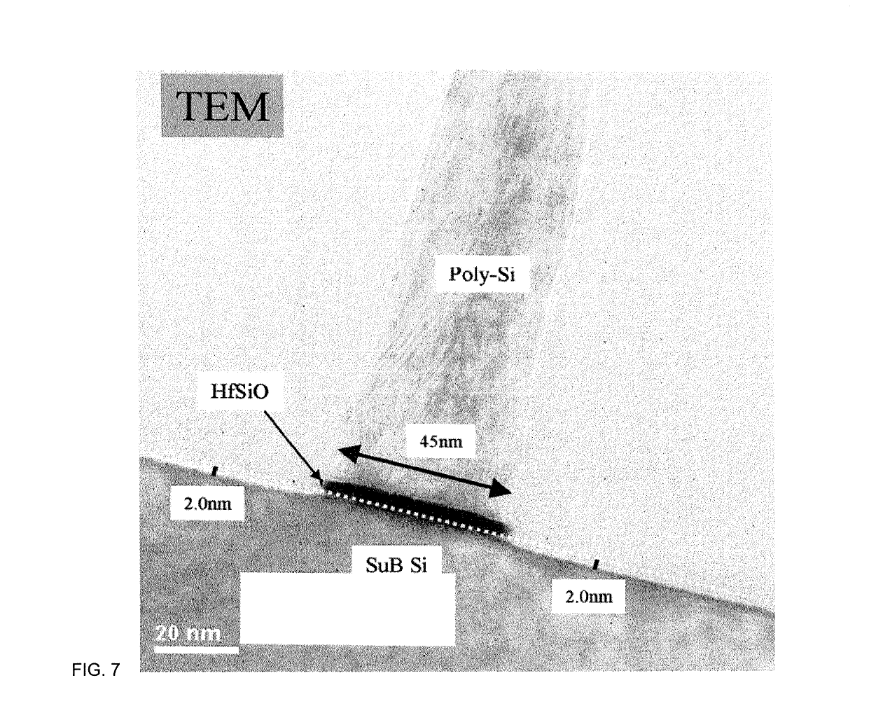

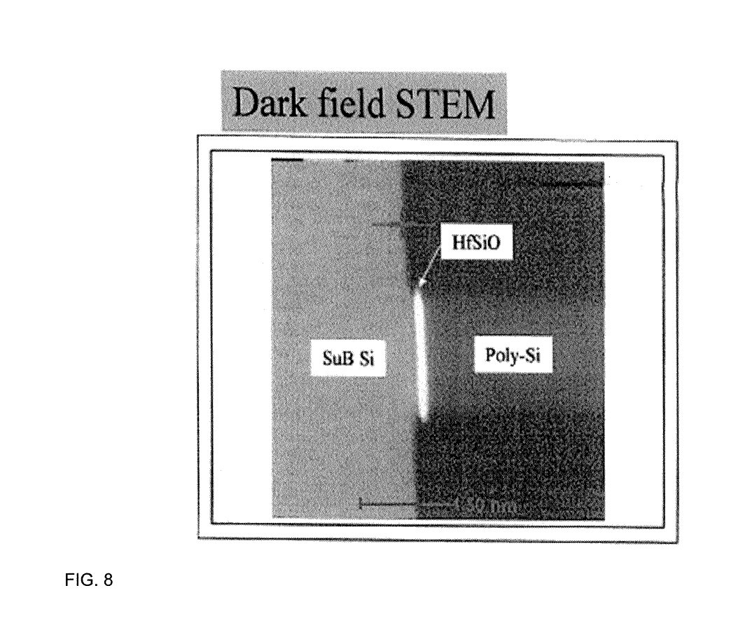

FIGS. 7 and 8 show process results for an example etch process performed on a substrate in accordance with the present invention. Specifically a substrate having an HfSiO layer and a polysilicon layer was provided in a capacitively coupled plasma system as schematically shown in FIG. 2. An HBr/O2 gas was provided in the chamber at a chamber pressure of 20 mT and a gas flow rate of 52 sccm for HBr, 8 sccm for O₂. An RF power of 0 W was applied to the top electrode and a substrate bias of 200 W was applied to completely remove the unmasked polysilicon as shown in FIG. 6. Even after the polysilicon is removed, the plasma continued to be applied to over-etch the polysilicon for about 35 seconds resulting in an altering or treating of the surface of the exposed HfSiO layer. Once the HfSiO layer was sufficiently treated, the exposed HfSiO layer was wet-etched using a dilute HF(aq) solution. The wet etch process parameters were an H₂O:HF ratio of 200:1 for about 30 seconds, which provided an etch rate of about 120 Å/minute, substantially faster than 30-40 Å/minute rate of the prior art process.

FIG. 7 shows a TEM image of a gate stack following plasma processing and wet etch of the HfSiO layer according to the process described above. As seen in this figure, the exemplary method provides an HfSiO etch with approximately 1.5-2.5 nm of Si recess. An Si recess of about 3.0 nm or less is generally considered an acceptable value. Further, FIG. 8 shows a Dark Field STEM image of a gate stack following plasma processing and wet etch of the HfSiO layer according to an embodiment of the invention. As seen in this figure, the undercut of the HfSiO layer was about 1 nm, or about 0-2.2% of the design width of the gate stack, which is also generally considered acceptable. Thus, the embodiment of the invention providing the results of FIGS. 7 and 8 provides an improved etch rate and acceptable Si recess and undercut results.

Although only certain embodiments of this invention have been described in detail above, those skilled in the art will readily appreciate that many modifications are possible in the embodiments without materially departing from the novel teachings and advantages of this invention. Accordingly, all such modifications are intended to be included within the scope of this invention.

What is claimed is:

1. A method of etching a hafnium containing layer on a substrate, comprising:
disposing said substrate having said hafnium containing layer in a plasma processing system, wherein a mask layer defining a pattern therein overlies said hafnium containing layer;
introducing a process gas comprising a HBr gas to said plasma processing system;
forming a plasma from said process gas in said plasma processing system;
exposing said hafnium containing layer of said substrate to said plasma in order to treat the hafnium containing layer; and
wet etching the hafnium containing layer using a dilute HF wet etch process.

2. The method of claim 1, wherein said disposing comprises disposing said substrate having the hafnium containing layer and an overlying polysilicon layer thereon in the plasma processing system, the method further comprising:
exposing the substrate to the plasma in order to etch the pattern into the polysilicon layer thereby revealing the hafnium containing layer.

3. The method of claim 2, wherein said exposing the hafnium containing layer comprises using the plasma to over etch the polysilicon layer for approximately 35 seconds.

4. The method of claim 3, wherein said introducing a process gas comprises:
introducing a gas flow of HBr at 52 sccm,
introducing a gas flow of O₂ at 8 sccm, and
maintaining at a chamber pressure of the plasma processing system at about 20 mT.

5. The method of claim 4, wherein said forming a plasma comprises:
providing 0 watts of RF power on a top electrode of the plasma processing system, and
providing 200 watts of RF power on a substrate holder of the plasma processing system.

6. The method of claim 3, wherein said wet etching comprises wet etching the hafnium containing layer using a solution having a H₂O:HF ratio of about 200:1.

7. The method of claim 6, wherein said wet etching is performed for approximately 30 seconds.

8. The method of claim 1, wherein said disposing comprises disposing in the plasma processing system a substrate having a hafnium oxide layer or a hafnium silicate layer or both a hafnium oxide layer and a hafnium silicate layer thereon.

9. The method of claim 1, wherein said introducing comprises introducing an inert gas to said plasma processing system, said inert gas comprising He, Ne, Ar, Kr or Xe, or a combination of two or more thereof.

10. The method of claim 9, wherein said introducing comprises introducing Ar at a flow rate of 1-500 sccm.

11. The method of claim 1, wherein said introducing comprises introducing a process gas comprising HBr, O₂ and He.

12. The method of claim 11, wherein said introducing comprises:
introducing the HBr process gas at a flow rate of 40-500 sccm,
introducing the O₂ gas at a flow rate of 1-20 sccm, and
introducing the He gas at a flow rate of 50-500 sccm.

13. The method of claim 11, wherein said introducing, forming and exposing are performed at a chamber pressure of approximately 10-150 mT.

14. The method of claim 11, further comprising:
providing RF power of 0-300 W to a top electrode of the plasma processing system; and
providing RF power at 50-300 W to said substrate holder of the plasma processing system.

15. The method of claim 11, wherein said wet etching comprises using a solution having a H₂O:Hf ratio of from 100:1 to 400:1.

16. The method of claim 15, wherein said wet etch process is performed for about 10-120 seconds.

17. A computer readable medium containing program instructions for execution on a computer system coupled to a plasma processing system, which when executed by the computer system cause the plasma processing system to a perform a process comprising the steps of claim 1.

18. A method of etching a hafnium containing layer on a substrate, comprising:
disposing the substrate having the hafnium containing layer in a plasma processing system, wherein a mask layer defining a pattern therein overlies the hafnium containing layer;
introducing a process gas comprising HBr and O₂ into the plasma processing system;
forming a plasma from said process gas in the plasma processing system;
exposing the hafnium containing layer of said substrate to said plasma in order to treat the hafnium layer; and
wet etching the hafnium containing layer using a H₂O:Hf solution at an etch rate of approximately 120 Å per minute.

19. A method of etching a hafnium containing layer on a substrate, comprising:
disposing said substrate in a plasma processing system, the substrate having said hafnium containing layer thereon, a polysilicon layer provided on the hafnium containing layer, and a mask layer provided on the polysilicon layer;
introducing a process gas comprising a HBr gas to said plasma processing system;
forming a plasma from said process gas in said plasma processing system;
over etching said polysilicon layer using said plasma in order to treat the hafnium containing layer; and
wet etching the treated hafnium containing layer using an HF wet etch process.

20. The method of claim 20, wherein said over etching is performed from approximately 35 seconds.
